(19) United States
(12) Patent Application Publication
(10) Pub. No.: US 2021/0215242 A1
(43) Pub. Date: Jul. 15, 2021

(54) TORSIONAL ACTUATOR

(71) Applicant: ZF Friedrichshafen AG, Friedrichshafen (DE)

(72) Inventors: Andreas Vath, Leidersbach (DE); Sebastian Schmidt, Zellingen (DE); Michael Wuerr, Hafenlohr-Windheim (DE)

(21) Appl. No.: 16/967,420

(22) PCT Filed: Jan. 10, 2019
(86) PCT No.: PCT/EP2019/050494

§ 371 Date: Aug. 5, 2020

(30) Foreign Application Priority Data
Feb. 7, 2018 (DE) 10 2018 201 905.3

(51) Int. Cl. F16H 57/00; F16H 57/02; F16F 15/00

(52) U.S. Cl. CPC F16H 57/0006; F16H 57/02; F16H 2057/02078; F16H 2057/0012; F16H 2057/02034; F16F 15/002

(57) ABSTRACT

A transmission designed to transmit a torque flow from a driving device to a driven device. The transmission includes an actuator including a rotor and a stator. The transmission further includes an output or an input shaft. The rotor is connected non-rotatably to the output shaft or to the input shaft, and the actuator and the driven device are arranged at different ends of the output shaft or the input shaft. The actuator is different from the driving device and the driven device.

### CROSS REFERENCE TO RELATED APPLICATIONS

This application is a U.S. National Stage Application under 35 U.S.C. § 371 of International Application No. PCT/EP2019/050494 filed on Jan. 10, 2019, and claims benefit to German Patent Application No. DE 10 2018 201 905.3 filed on Feb. 7, 2018. The International Application was published in German on Aug. 15, 2019 as WO 2019/154578 A1 under PCT Article 21 (2).

### FIELD

The invention relates to a transmission having at least one actuator, the transmission being designed to transmit a torque flow from a driving device to a driven device.

### BACKGROUND

Active damping systems for reducing torsional vibrations in a transmission are known from the prior art. These systems use linear actuators. For damping torsional vibrations, linear actuators must be arranged in pairs at a distance from an axis of rotation of the vibration to be damped. For example, actuators are known which act on the torque supports of a transmission. In principle, it is not possible for a linear actuator to act directly on a rotating shaft.

Flexible couplings and dual-mass flywheels for damping torsional vibrations of rotating shafts are known from the prior art. These are passive systems which can only to a limited extent reduce the vibrations to be damped.

### SUMMARY

In an embodiment, the present invention provides a transmission designed to transmit a torque flow from a driving device to a driven device. The transmission includes an actuator including a rotor and a stator. The transmission further includes an output shaft or an input shaft. The rotor is connected non-rotatably to the output shaft or to the input shaft, and the actuator and the driven device are arranged at different ends of the output shaft or the input shaft. The actuator is different from the driving device and the driven device.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a transmission with a sensor and a first actuator variant; and

FIG. 2 illustrates a transmission with a sensor and a second actuator variant.

### DETAILED DESCRIPTION

The present disclosure provides for addressing the disadvantages inherent in solutions known from the prior art. In particular, torsional vibrations in transmissions with rotating shafts should be damped as effectively as possible.

According to the present disclosure, a transmission, which may be, for example, a wind turbine gearbox, has at least one actuator. An actuator is a means which influences a physical quantity as a function of a signal supplied to the actuator. A signal, in turn, is a physical quantity in which one or more parameters carry information about one or more variable quantities. In the present case, it is preferably an electrical signal.

The transmission is designed to transmit a torque flow from a driving device to a driven device. Transmission of the torque flow denotes the transmission of an input torque, which is applied to an input shaft of the transmission, via intermediate shafts to an output shaft of the transmission.

The input shaft and the output shaft form coupling points for the driving device and the driven device. The input torque is applied to the input shaft via the driving device. The output torque thus applied to the output shaft is transmitted to the driven device.

The driving device may be, for example, the rotor of a wind turbine, to whose rotor blades the input torque is applied by the wind. Accordingly, the driven device may be a generator of the wind turbine.

The actuator is different from both the driving device and the driven device. Neither the driving device nor the driven device is therefore the actuator. Nor is the actuator part of the driving device or part of the driven device. Three different devices are thus present: actuator, driving device and driven device. This implies that the rotor is not equipped with any of the coupling points for the driven or the driving device.

According to the disclosure, the actuator comprises a rotor and a stator. It is therefore not a linear actuator but, rather, a rotating actuator. The rotor, which is rotatably mounted relative to the stator, is in this case designed to rotate. The stator is rotationally fixed. The aforementioned physical quantity, which is in a dependent relationship with the signal supplied to the actuator, is, in the case of the present invention, a torque acting between the rotor and the stator. A direction vector of the torque and an axis of rotation of a shaft of the transmission are coincident and run in particular in parallel.

According to the disclosure, the rotor is connected non-rotatably to said shaft.

As a result, the torque acting between the rotor and the stator is transmitted to the shaft.

The vibration behavior of the transmission can in particular be influenced by the transmitted torque. The rotor acts directly on the shaft. A particularly precise influence is therefore possible. A further advantage lies in the compact design of the rotary actuator.

The rotor can be a separate component. In a preferred development, however, the shaft forms the rotor. This implies that the rotor and the shaft are integrally connected to each other. An eddy current brake, which acts on the shaft and induces eddy currents in the shaft, is a possibility for the stator according to a development.

The shaft to which the rotor is connected in a rotationally fixed manner can be any shaft of the transmission, thus even its intermediate shafts. In a preferred development, the shaft is however the output shaft. In this case, the actuator and the driven device are arranged at different, opposite ends of the output shaft. The shaft end on which the actuator is arranged is opposite the aforementioned coupling point for the driven device. The rotor of the actuator is non-rotatably connected to the shaft end, or the shaft end forms the rotor.

Alternatively, the shaft may be the input shaft. The actuator and the driving device are then arranged on different shafts of the input shaft. The end of the output shaft on which the actuator is arranged is the end opposite the aforementioned coupling point. Here, too, the rotor of the actuator is connected non-rotatably to the shaft end, or the shaft end forms the rotor of the actuator.

In a further preferred development, the actuator is arranged at least partially, preferably completely, within a transmission housing of the transmission.

In a preferred development, at least one sensor is provided to measure the vibrations to be damped. This sensor is preferably designed to measure the vibrations of the shaft on which the torque of the actuator acts.

The transmission is preferably part of an arrangement with at least one control unit. The sensor is connected to the control unit in a signal-conducting manner so that the control unit receives information about the measured vibrations. The control unit is designed to operate the actuator in such a way that the vibrations are eliminated or damped. For this purpose, there is also a signal-conducting connection from the control unit to the actuator. Via this connection, the control unit supplies the actuator with a signal, as a function of which the actuator influences the torque acting between the rotor and the stator.

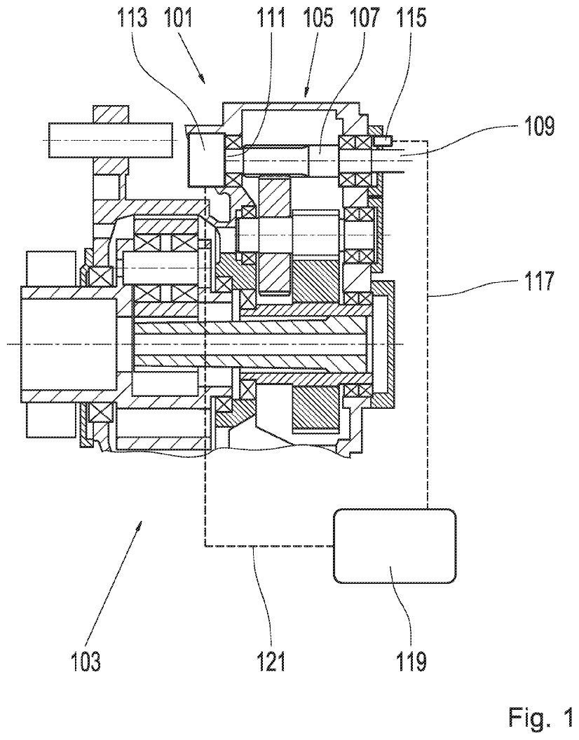

The transmission 101 shown in FIG. 1 has an input-side planetary stage 103 and an output-side spur gear stage 105. The spur gear stage 105 includes an output shaft 107. At a generator-side end 109, the output shaft can be connected non-rotatably to a rotor of a generator.

A rotor-side end 111 of the output shaft 107 is opposite the generator-side end 109. An actuator 113 is arranged there. A torque of the actuator 113 acts on the rotor-side end 111 of the output shaft 107.

The aim is to eliminate torsional vibrations of the output shaft 107. The vibrations to be eliminated are detected by a sensor 115. A corresponding measurement signal 117 is passed to a control unit 119 and acquired and processed by the same.

Depending on the measurement signal 117, the control unit 119 generates an actuating signal 121 which is passed to the actuator 113 and controls the same. The torque applied by the actuator 113 to the output shaft 107 is dependent on the actuating signal 121. The control unit 119 calculates the actuating signal 121 in such a way that the torque corresponds to a counter-vibration to the vibration measured by the sensor 115.

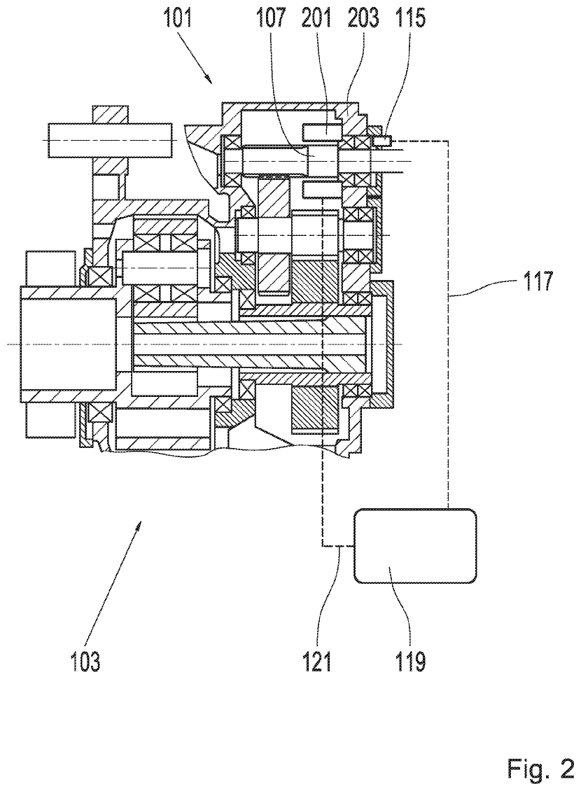

FIG. 2 shows an actuator 201 which performs the same function as the actuator 113 shown in FIG. 1 but which, unlike the actuator 113, is arranged within a housing 203 of the transmission 101. The actuator 201 has no separate rotor. The output shaft 107 serves as a rotor here. This means that a stator of the actuator 201 applies a torque directly to the output shaft 107. This can be realized, for example, by means of an eddy current brake serving as actuator 201.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

101 Transmission
103 Planetary stage
105 Spur gear stage
107 Output shaft
109 Generator-side end of the output shaft
111 Rotor-side end of the output shaft
113 Actuator
115 Sensor
117 Measurement signal
119 Control unit
121 Actuating signal
201 Actuator
203 Housing

1-8. (canceled)

9. A transmission designed to transmit a torque flow from a driving device to a driven device, the transmission comprising:
an actuator, the actuator including a rotor and a stator; and
an output shaft,
wherein the rotor is connected non-rotatably to the output shaft,
wherein the actuator and the driven device are arranged at different ends of the output shaft, and
wherein the actuator is different from the driving device and the driven device.

10. A transmission designed to transmit a torque flow from a driving device to a driven device, the transmission comprising:
an actuator, the actuator including a rotor and a stator; and
an input shaft,
wherein the rotor is connected non-rotatably to the input shaft;
wherein the actuator and the driving device are arranged at different ends of the input shaft, and
wherein the actuator is different from the driving device and the driven device.

11. The transmission according to claim 9, wherein the output shaft forms the rotor.

12. The transmission according to claim 9, further comprising:
a transmission housing,
wherein the actuator is arranged at least partially within the transmission housing.

13. The transmission according to claim 9, further comprising:
at least one sensor;
wherein the at least one sensor is configured to measure vibrations of the output shaft.

14. An arrangement comprising a transmission according to claim 13, the arrangement further comprising:
at least one control unit,
wherein the at least one sensor is connected to the at least one control unit in a signal-conducting manner, and
wherein the at least one control unit is designed to operate the actuator in such a way that the vibrations are damped.

15. The transmission according to claim 10, wherein the input shaft forms the rotor.

16. The transmission according to claim 10, further comprising:
a transmission housing,
wherein the actuator is arranged at least partially within the transmission housing.

17. The transmission according to claim 10, further comprising:
at least one sensor;
wherein the at least one sensor is configured to measure vibrations of the input shaft.

18. An arrangement comprising a transmission according to claim 17, the arrangement further comprising:
at least one control unit,
wherein the at least one sensor is connected to the at least one control unit in a signal-conducting manner, and
wherein the at least one control unit is designed to operate the actuator in such a way that the vibrations are damped.
